(19) United States
(12) Patent Application Publication
(10) Pub. No.: US 2025/0307704 A1
(43) Pub. Date: Oct. 2, 2025

(54) METHODS, APPARATUSES, DEVICES AND MEDIUM FOR MODEL PERFORMANCE EVALUATION

(71) Applicants: Beijing Bytedance Network Technology Co., Ltd., Beijing (CN); Lemon Inc., Grand Cayman (KY)

(72) Inventors: Jiankai SUN, Los Angeles, CA (US); Xin YANG, Los Angeles, CA (US); Chong WANG, Los Angeles, CA (US); Junyuan XIE, Beijing (CN); Di WU, Beijing (CN)

(21) Appl. No.: 18/865,581

(22) PCT Filed: Apr. 27, 2023
(86) PCT No.: PCT/CN2023/091189

§ 371 Date: Nov. 13, 2024

(30) Foreign Application Priority Data
May 13, 2022 (CN) 202210524865.2

(51) Int. Cl. G06N 20/00

(52) U.S. Cl. CPC G06N 20/00

(57) ABSTRACT

According to embodiments of the disclosure, methods, apparatuses, devices and medium for model performance evaluation are provided. A method includes: applying, at a client node, a plurality of data samples to a prediction model respectively to obtain a plurality of predicted scores output by the prediction model, the plurality of predicted scores indicating respectively predicted probabilities that the plurality of data samples belong to a first category or a second category; determining values of a plurality of metric parameters related to a predetermined performance indicator of the prediction model based on the plurality of predicted scores and a plurality of ground-truth labels of the plurality of data samples; performing perturbation on the values of the plurality of metric parameters to obtain perturbed values of the plurality of metric parameters; and sending the perturbed values of the plurality of metric parameters to a server node.

This application claims priority to Chinese invention patent application No. 202210524865.2, filed on May 13, 2022 and entitled “METHODS, APPARATUSES, DEVICES AND MEDIUM FOR MODEL PERFORMANCE EVALUATION”.

### FIELD

Example embodiments of the present disclosure generally relate to the field of computer, particularly to methods, apparatuses, devices and computer readable storage medium for model performance evaluation.

### BACKGROUND

Currently, machine learning has been widely applied, and its performance usually improves with the increase of data volume. In some solutions, it is necessary to concentrate sufficient collection of data samples and label data for training machine learning models. However, in many real-world scenarios, there is a problem of so-called data silos, where data is usually dispersed and isolated, stored on different entities (e.g., enterprises, user ends). With the increasing attention paid to data privacy protection issues, such centralized machine learning is difficult to achieve the purpose of data protection.

Currently, a federated learning solution has been proposed. Federated learning refers to using the data of each node to achieve collaborative modeling and improve the effectiveness of machine learning models on the basis of ensuring data privacy and security. Federated learning can allow each node to stay at the end to achieve data protection purposes.

### SUMMARY

A solution for model performance evaluation is provided based on the example embodiments of the present disclosure.

In a first aspect of the present disclosure, a method of model performance evaluation is provided. The method includes: applying, at a client node, a plurality of data samples to a prediction model respectively to obtain a plurality of predicted scores output by the prediction model, the plurality of predicted scores indicating respectively predicted probabilities that the plurality of data samples belong to a first category or a second category; determining values of a plurality of metric parameters related to a predetermined performance indicator of the prediction model based on the plurality of predicted scores and a plurality of ground-truth labels of the plurality of data samples; performing perturbation on the values of the plurality of metric parameters to obtain perturbed values of the plurality of metric parameters; and sending the perturbed values of the plurality of metric parameters to a server node.

In a second aspect of the present disclosure, a method of model performance evaluation is provided. This method includes: receiving, at a server node, perturbed values of a plurality of metric parameters related to a predetermined performance indicator of a prediction model from a plurality of client nodes, respectively; aggregating the perturbed values of the plurality of metric parameters from the plurality of client nodes in a metric parameter-wise way, to obtain aggregated values of the plurality of metric parameters; and determining a value of the predetermined performance indicator based on the aggregated values of the plurality of metric parameters.

In a third aspect of the present disclosure, an apparatus for model performance evaluation is provided. The apparatus includes: prediction module configured to apply a plurality of data samples to a prediction model respectively, to obtain a plurality of predicted scores output by the prediction model, the plurality of predicted scores indicating predicted probabilities that the plurality of data samples belonging to a first category or a second category, respectively; a metric determination module configured to determine values of a plurality of metric parameters related to a predetermined performance indicator of the prediction model based on the plurality of predicted scores and a plurality of ground-truth labels of the plurality of data samples; a perturbation module configured to perform perturbation on the values of the plurality of metric parameters to obtain perturbed values of the plurality of metric parameters; and a sending module configured to send the perturbed values of the plurality of metric parameters to a server node.

In a fourth aspect of the present disclosure, an apparatus for model performance evaluation is provided. The apparatus includes: a receiving module configured to receive, from a plurality of client nodes, perturbed values of a plurality of metric parameters related to a predetermined performance indicator of a prediction model, respectively; an aggregation module configured to aggregate the perturbed values of the plurality of metric parameters from the plurality of client nodes in a metric parameter-wise way, to obtain aggregated values of the plurality of metric parameters; and a performance determination module configured to determine a value of the predetermined performance indicator based on the aggregated values of the plurality of metric parameters.

In a fifth aspect of the present disclosure, an electronic device is provided. The device includes at least one processing unit; and at least one memory coupled to the at least one processing unit and storing instructions for execution by the at least one processing unit. The instructions, when executed by the at least one processing unit, causes the device to perform the method of the first aspect.

In a sixth aspect of the present disclosure, an electronic device is provided. The device includes at least one processing unit; and at least one memory coupled to the at least one processing unit and storing instructions for execution by the at least one processing unit. The instructions, when executed by the at least one processing unit, causes the device to perform the method of the second aspect.

In a seventh aspect of the present disclosure, a computer readable storage medium is provided. The medium has a computer program stored thereon which is executed by a processor to implement the method of the first aspect.

In an eighth aspect of the present disclosure, a computer readable storage medium is provided. The medium has a computer program stored thereon which is executed by a processor to implement the method of the first aspect.

It should be understood that the content described in this SUMMARY is not intended to limit the key or important features of the embodiments of the present disclosure, nor is it intended to limit the scope of the present disclosure. The other features of the present disclosure will become easily understandable through the following description.

### BRIEF DESCRIPTION OF THE DRAWINGS

The above and other features, advantages and aspects of various embodiments of the present disclosure will become more apparent with reference to the following detailed description taken in conjunction with the accompanying drawings. In the drawings, the same or similar reference numeral represents the same or similar elements, where:

FIG. 1 illustrates a schematic diagram of an example environment in which the embodiments of the present disclosure can be applied;

FIG. 2 illustrates a flowchart of a signaling flow for model performance evaluation according to some embodiments of the present disclosure;

FIG. 3A illustrates a flowchart of a process of determining values of metric parameters according to some embodiments of the present disclosure;

FIG. 3B illustrates a flowchart of a process of determining values of metric parameters according to some embodiments of the present disclosure;

FIG. 4 illustrates a flowchart of a process for model performance evaluation at a client node according to some embodiments of the present disclosure;

FIG. 5 illustrates a flowchart of a process for model performance evaluation at a server node according to some embodiments of the present disclosure;

FIG. 6 illustrates a block diagram of an apparatus for model performance evaluation at a client node according to some embodiments of the present disclosure;

FIG. 7 illustrates a block diagram of an apparatus for model performance evaluation at a server node according to some embodiments of the present disclosure; and

FIG. 8 illustrates a block diagram of a computing device/system capable of implementing one or more embodiments of the present disclosure.

### DETAILED DESCRIPTION

Embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including” and similar terms should be understood as open-ended inclusion, that is, “including but not limited to”. The term “based on” should be understood as “at least partially based on”. The terms “one embodiment” or “the embodiment” should be understood as “at least one embodiment”. The term “some embodiments” should be understood as “at least some embodiments”. The following may also include other explicit and implicit definitions.

It can be understood that the data involved in this technical solution (including but not limited to the data itself, data observation or use) should comply with the requirements of corresponding laws, regulations and relevant provisions.

It is to be understood that, before applying the technical solutions disclosed in various implementations of the present disclosure, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that execute operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “model” may learn the correlation relationship between corresponding inputs and outputs from training data, so that corresponding outputs may be generated for given inputs after training. The generation of the model may be based on machine learning technology. Deep learning is a machine learning algorithm that processes inputs and provides corresponding outputs by using a plurality of layers of processing units. Neural networks models are an example of deep learning-based models. Herein, “model” may also be referred to as “machine learning model”, “learning model”, “machine learning network”, or “learning network”, and these terms are used interchangeably herein.

A “neural network” is a machine learning network based on deep learning. Neural networks are capable of processing inputs and providing corresponding outputs, and typically include an input layer and an output layer and one or more hidden layers between the input layer and the output layer. Neural networks used in deep learning applications often include many hidden layers, thereby increasing the depth of the network. The layers of a neural network are connected in sequence such that the output of the previous layer is provided as the input of the subsequent layer, where the input layer receives the input of the neural network, and the output of the output layer serves as the final output of the neural network. Each layer of a neural network includes one or more nodes (also referred to as processing nodes or neurons), each of which processes input from the previous layer.

Generally, machine learning may roughly include three stages, namely a training stage, a testing stage and an application stage (also referred to as an inference stage). In the training stage, a given model may be trained using a large amount of training data, and parameter values are continuously updated iteratively until the model may obtain consistent inferences from the training data that meet the expected goals. Through training, the model may be thought of as being able to learn associations from inputs to outputs (also referred to as input-to-output mappings) from the training data. The parameter values of the trained model are determined. In the testing stage, test inputs are applied to the trained model to test whether the model may provide the correct output, thereby determining the performance of the model. In the application stage, the model may be used to process the actual input and determine the corresponding output based on the parameter values obtained through training.

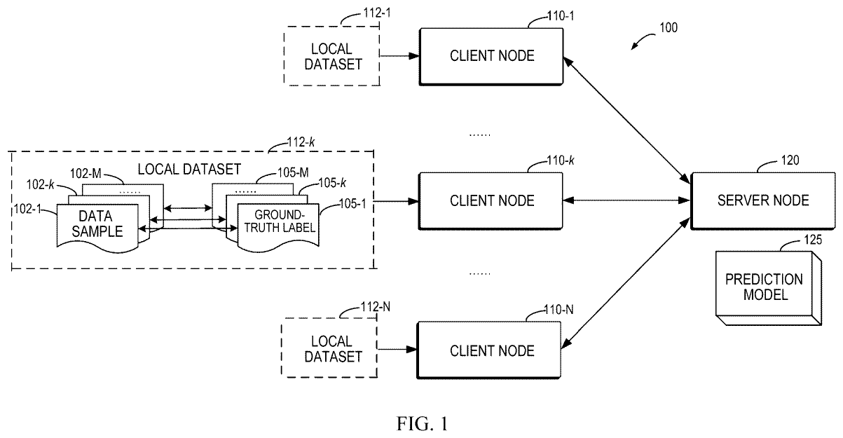

FIG. 1 illustrates a schematic diagram of an example environment 100 in which the embodiments of the present disclosure can be implemented. The environment 100 involves a federated learning environment, which includes N client nodes 110-1, . . . 110-k, . . . 110-N (where N is an integer greater than 1, k=1, 2, . . . N), and a server node 120. The client nodes 110-1, . . . 110-k, . . . 110-N may maintain their respective local datasets 112-1, . . . 112-k, . . . 112-N. For the sake of discussion, the client nodes 110-1, . . . 110-k, . . . 110-N may be collectively or individually referred to as client nodes 110, and the local datasets 112-1, . . . 112-k, . . . 112-N may be collectively or individually referred to as local datasets 112.

In some embodiments, the client node 110 and/or the server node 120 may be implemented at a terminal device or a server. The terminal device may be any type of mobile terminal, fixed terminal, or portable terminal, including mobile phones, desktop computers, laptop computers, notebook computers, netbook computers, tablet computers, media computers, multimedia tablets, personal communication system (PCS) devices, personal navigation devices, personal digital assistants (PDAs), audio/video player, digital cameras/camcorders, positioning devices, television receivers, radio broadcast receivers, electronic book devices, gaming devices, or any combination of the foregoing, including accessories and peripherals of these devices, or any combination thereof. In some embodiments, the terminal device may also be able to support any type of interface to the user (such as “wearable” circuitry, etc.). Servers are various types of computing systems/servers that can provide computing power, including but not limited to mainframes, edge computing nodes, computing devices in cloud environments, and the like.

In federated learning, a client node refers to a node that provides part of data for application training, verification or evaluation of prediction models. The client node may also be referred to as a client, a terminal node, a terminal device, a user equipment, etc. In federated learning, a server node refers to a node that aggregates the results at the client node.

In the example in FIG. 1, assume that N client node 110 jointly participate in the training of a prediction model 125, and collect the intermediate results in the training to the server node 120, so that the server node 120 may update a parameter set of the prediction model 125. The complete set of local data of these client nodes 110 constitute a complete training data set of the prediction model 125. Therefore, according to the federated learning mechanism, the server node 120 may determine a global prediction model 125.

For the prediction model 125, the local data set 112 at the client node 110 may include data samples and ground-truth labels. FIG. 1 specifically illustrates the local data set 112-k at the client node 110-k, which includes a data sample set and a ground-truth label set. The data sample set includes multiple (M) data samples 102-1, 102-i, . . . 102-M (collectively or individually referred to as data sample 102), and the ground-truth label set includes a corresponding multiple (M) ground-truth labels 105-1, 105-i, . . . 105-M (collectively or individually referred to as ground-truth label 105). Herein, M is an integer greater than 1, i=1, 2, . . . M. Each data sample 102 may be marked shows with a corresponding ground-truth label 105. The data sample 102 may correspond to the input of the prediction model 125, and the ground-truth label 105 indicates the true output of the data sample 102. A ground-truth label is an important part of supervised machine learning.

In the embodiments of the present disclosure, the prediction model 125 may be constructed based on various machine learning or deep learning model architectures, and may be configured to implement various prediction tasks, such as various classification tasks, recommendation tasks, and so on. Accordingly, the prediction model 125 may also be referred to as a recommendation model, a classification model, and the like.

The data sample 102 may include input information related to the specific task of the prediction model 125, and the ground-truth label 105 is related to the expected output of the task. As an example, in a binary classification task, the prediction model 125 may be configured to predict whether the data sample input belongs to a first category or a second category, and the ground-truth label is used to mark that the data sample actually belongs to the first category or the second category. Many practical applications may be classified as such binary tasks, such as the conversion of recommended items (such as clicking, purchasing, registering, or other demand behaviors) in a recommendation task, and so on.

It should be understood that FIG. 1 only illustrates an example of the federated learning environment. According to federated learning algorithms and practical application needs, the environment may also be different. For example, although illustrated as a separate node, in some applications, the server node 120 may also serve as a client node in addition to serving as a central node to provide part of data for model training, model performance evaluation, and so on. The embodiments of the present disclosure are not limited in this respect.

In the training phase of the prediction model 125, there are some mechanisms to protect the local data of each client node 110 from leakage. For example, during the model training, the client node 110 does not need to leak local data samples or label data, but sends gradient data computed based on to the local training data to the server node 120 for the server node 120 to update a parameter set of the prediction model 125.

In some cases, it is also expected to evaluate the performance of the trained prediction model. The evaluation of model performance also requires data, including data samples required for model input and the corresponding label data of data samples. The performance of the prediction model may be measured by one or more performance indicators. Different performance indicators may measure the difference between the predicted output given by the prediction model for the data sample set and the true output indicated by the ground-truth label set from different perspectives. Generally, if the difference between the predicted output given by the prediction model and the true output is small, it means that the performance of the prediction model is better. It can be seen that the performance indicator of the prediction model usually needs to be determined based on the ground-truth label set of the data samples.

As the data supervision system continues to strengthen, the requirements for data privacy protection are becoming increasingly higher. The ground-truth labels of data samples also need to be protected to avoid being leaked. Therefore, it is a challenging task to determine the performance indicator of the prediction model and protect the local label data of the client node from leakage. There is currently no highly effective solution to address this issue.

According to the embodiments of the present disclosure, a model performance evaluation solution is provided, which may protect the local label data of the client node. Specifically, at a client node, after computing the values of a plurality of metric parameters related to a performance indicator of the prediction model, perturbation is applied to the determined values of the metric parameters to obtain the perturbed values of the plurality of metric parameters. The client node sends the perturbed values of the metric parameters to a server node. Since there is no need to directly send the true values of the metric parameters, it is difficult for observers to derive the ground-truth labels of data samples from the perturbed values. This may effectively avoid data leakage.

At a server node, the server node receives perturbed values of a plurality of metric parameters determined by a plurality of client nodes. The server node aggregates the perturbed values of the plurality of metric parameters from the plurality of client nodes in a metric parameter-wise way. After aggregating the perturbed values from a plurality of different sources, the perturbation is cancelled out. Therefore, based on the aggregated values of the plurality of metric parameters, the server node may accurately determine a value of the performance indicator of the model.

According to the embodiments of the present disclosure, each client node does not need to expose the local ground-truth label set or the parameter value determined based on the ground-truth labels, and may also allow the server node to compute the performance indicator value of the model. In this way, the privacy protection of the local label data of the client node is achieved while model performance evaluation is implemented.

The following will continue to describe some example embodiments of the present disclosure with reference to the accompanying drawings.

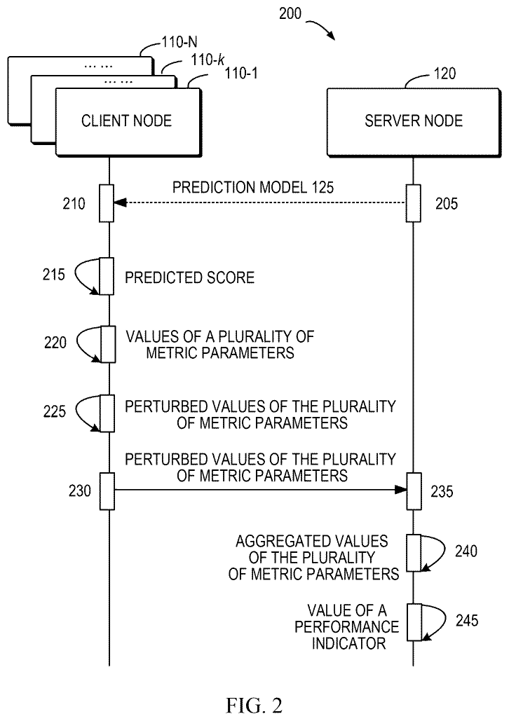

FIG. 2 illustrates a schematic block diagram of a signaling flow 200 for model performance evaluation according to some embodiments of the present disclosure. For ease of discussion, refer to the environment 100 in FIG. 1 for discussion. The signaling flow 200 involves the client node 110 and the server node 120.

In the embodiments of the present disclosure, it is assumed that the performance of the prediction model 125 is to be evaluated. In some embodiments, the prediction model 125 to be evaluated may be a global prediction model determined based on the training process of federated learning, such as the client node 110 and the server node 120 participating in the training process of the prediction model 125. In some embodiments, the prediction model 125 may also be a model obtained in any other way, and the client node 110 and the server node 120 may not participate in the training process of the prediction model 125. The scope of the present disclosure is not limited in this regard.

In some embodiments, as shown in the signaling flow 200, the server node 120 sends 205 the prediction model 125 to N client nodes 110. After receiving 210 the prediction model 125, each client node 110 may perform a subsequent evaluation process based on the prediction model 125. In some embodiments, the prediction model 125 to be evaluated may also be provided to the client node 110 in any other appropriate manner.

In the embodiments of the present disclosure, the operation of the client side is described from the perspective of a single client node 110. A plurality of client nodes 110 may operate similarly.

In signaling flow 200, the client node 110 applies 215 the model 125 to the plurality of data samples to obtain a plurality of predicted score output by the prediction model 125. Assuming that the data sample set of the client node 110-k is Xₖ and the prediction model 125 is represented as f( ), the predicted scores set for the data sample set may be represented as s^{k}=f(Xₖ).

In the embodiments of the present disclosure, particular attention is paid to the performance indicators of the prediction model in implementing a binary classification task. Each predicted score may indicate predicted probabilities that the corresponding data sample 102 belongs to the first category or the second category. These two categories may be configured based on the actual task requirements.

The value range of predicted score output by the prediction model 125 may be set arbitrarily. For example, the predicted score may be a value in a continuous value range (for example, a value between 0 and 1), or it may be a value in multiple discrete values (for example, it may be one of the discrete values such as 0, 1, 2, 3, 4, and 5). In some examples, a higher prediction score can indicate a higher probability of data sample 102 belonging to the first category and a lower probability of belonging to the second category. Of course, the opposite setting is also possible. For example, a higher prediction score can indicate that the probability of data sample 102 belonging to the second category is higher, while the probability of belonging to the first category is lower.

The client node 110 determines 220 values of a plurality of metric parameter related to a predetermined performance indicator of the prediction model 125 based on a plurality of ground-truth label (also referred to as true value labels) of the plurality of data samples 102 and the plurality of predicted scores output by the model.

The ground-truth label 105 is used to mark that the corresponding data sample 102 belongs to the first category or the second category. In the following, for the convenience of discussion, data samples belonging to the first category are sometimes referred to as positive samples, positive examples or positive-category samples, and data samples belonging to the second category are sometimes referred to as negative samples, negative examples or negative-category samples. In some embodiments, each ground-truth label 105 may have one of two values, which are respectively used to indicate the first category or the second category. In the following embodiments, for the sake of discussion, the value of the ground-truth label 105 corresponding to the first category may be set to “1”, which indicates that the data sample belongs to the first category and is a positive sample. In addition, the value of the ground-truth label 105 corresponding to the second category may be set to “0”, which indicates that the data sample belongs to the second category and is a negative sample.

In the embodiments of the present disclosure, the individual client node 110 determines metric information related to the performance indicator of the model based on the local data set (the data samples and ground-truth labels). By gathering the metric information of the plurality of client nodes 110 to the server node 120, it is equivalent to evaluating the performance of prediction model 125 based on the complete dataset of the plurality of client nodes.

The metric information refers to the information that needs to be concerned when computing the performance indicator of the model, which may usually be indicated by a plurality of metric parameters. The values of these metric parameters need to be computed based on the results (i.e., predicted score) of data samples after passing through the model, and the corresponding ground-truth value labels of data samples. The type of metric information provided by the client node may depend on the specific performance indicator to be computed.

In the following, for the sake of understanding, some example performance indicators of the prediction model 125 used to implement the binary classification task are first introduced.

The predicted score output by the prediction model 125 for a certain data sample is usually used to compare with a certain score threshold value, and based on the comparison results, it is determined that the data sample is predicted to belong to the first category or the second category. The prediction of the prediction model 125 used to implement the binary classification task may have four results.

Specifically, for a certain data sample 102, if the ground-truth label 105 indicates that it belongs to the first category (positive sample), and the prediction model 125 also predicts that it is a positive sample, then it is considered that the data sample is a true positive (TP) sample. If the ground-truth label 105 indicates that it belongs to the first category (positive sample), and the prediction model 125 predicts that it is a negative sample, then the data sample is considered as a false negative sample (FN). If the ground-truth label 105 indicates that it belongs to the second category (negative sample), but the prediction model 125 also predicts that it is a negative sample, then the data sample is considered to be true negative (TN). If the ground-truth label 105 indicates that it belongs to the second category (negative sample), but the prediction model 125 predicts that it is a positive sample, then the data sample is considered to be a false positive (FP). These four results may be indicated by a confusion matrix in Table 1 below.

TABLE 1

ground-truth label

| | | Positive (P) | Negative (N) |
|---|---|---|---|
| predicted | P′ | True (TP) | False positive (FP) |
| result | N′ | False negative (FN) | True Negative (FN) |

When measuring the performance of the prediction model 125, it is expected that performance indicator may be computed on the basis of the prediction results of the complete set of data samples of the plurality of client nodes 110 and the complete set of the ground-truth labels.

In some embodiments, the performance indicator of the prediction model 125 may further include a false positive sample ratio (FPR) and/or a true positive sample ratio (TPR). FPR may be defined as a ratio of the data sample that is actually a negative example and is wrongly judged as positive by the model, which is represented as FPR=FP/(FP+TN), where FP and TN represent the number of FP and TN counted in the complete set of data samples. TPR: a ratio of samples that are actually positive to those that are correctly judged as positive, represented as TPR=TP/(TP+FN).

In some embodiments, the performance indicator of the prediction model 125 may include an area under curve (AUC) of a receiver operating characteristic (ROC) curve.

The ROC curve is a curve drawing on the coordinate axis based on different classification ways (setting different score threshold values), with the false positive sample ratio (FPR) as the X-axis and the true sample ratio (TPR) as the Y-axis. Based on each possible score threshold value, coordinate points of a plurality of (FPR, TPR) pairs may be computed, and these points may be connected into a line to form the ROC curve for a specific model.

By definition, AUC refers to the area below the ROC curve. One possible way to compute AUC is to use an approximation algorithm to compute the area under the ROC curve based on the definition of AUC.

In some embodiments, the AUC may also be determined from a probabilistic perspective. The AUC may be considered as the probability that a positive sample and a negative sample are randomly selected, and the predicted score given by the prediction model to the positive sample is higher than the predicted score of the negative sample. That is, in the data sample set, the positive and negative samples meet to form a positive and negative sample pair, where the predicted score of the positive sample is greater than the proportion of the predicted score of the negative sample. If the model may output more positive samples with higher predicted score than negative samples, it may be considered that the AUC is higher, and the performance of the model is better. The range of AUC values is between 0.5 and 1. The closer the AUC is to 1, the better the performance of the model.

In the above AUC computing, the values of some metric parameters need to be determined based on the label data and prediction results of the data samples.

In addition to AUC, the performance indicators of the prediction model 125 may further include precision, which is represented as Precision=TP/TP+FP. The precision represents the probability of a subset of data samples 102 predicted as positive samples being marked as positive samples. The performance indicators of prediction model 125 may further include recall, which is represented as Recall=TP/TP+FN, that is, the probability of positive samples being predicted. The performance indicators of the prediction model 125 may further include the P-R curve, which takes the recall rate as the horizontal axis and the precision as the vertical axis. The closer the P-R curve is to the upper right corner, the better the performance of the model. The area under the area under curve is referred to as an Average Precision Score (AP) score.

In the following, the determination of AUC will be mainly discussed as an example. The AUC may have different computing ways, and different metric parameters are required under different computing ways.

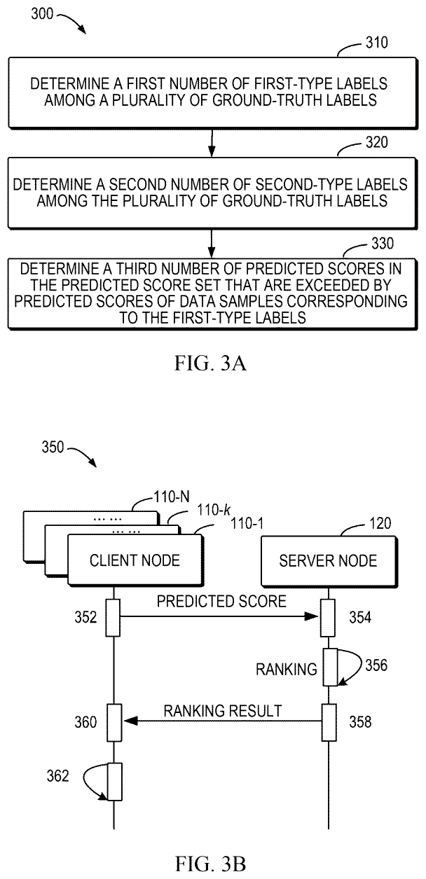

FIG. 3A illustrates a flowchart of a process 300 of determining values of metric parameters according to some embodiments of the present disclosure. The process 300 is used to determine the values of the metric parameters required in one computing way of AUC. The process 300 may be implemented at the client node 110.

In block 310, the client node 110 determines the number of first-category labels (referred to as “first number”) among the plurality of ground-truth labels 105, where the first-category label indicates that the corresponding data sample 102 belongs to the first category, for example, indicates that the data sample 102 is a positive sample. In block 320, the client node 110 may also determine the number of second-category label (referred to as “second number”) among the plurality of ground-truth labels 105. The second-category label here indicates that the corresponding data sample 102 belongs to the second category, for example, indicates that the data sample 102 is a negative sample.

At the client node 110-k, the determination of the first number and the second number may be represented as follows:

$${localP}_{k} = {\sum }_{i = 1}^{\vert {X}_{k} \vert} {y}_{i}^{k} \qquad ( 1 )$$

$${localN}_{k} = \vert {X}_{k} \vert - {localP}_{k} \qquad ( 2 )$$

Where |Xₖ| represents the total number of the data sample 102 of the client node 110-k; yᵢ^{k} represents the value of the ground-truth label 105 corresponding to the i^{th} data sample 102; localPₖ represents the number of first-category label (labels indicating positive samples) at the client node 110-k, and localNₖ represents the number of second-category label (labels indicating negative samples) in the ground-truth labels 105 at the client node 110-k.

In the above equations (1) and (2), assume that the value of yᵢ^{k} is 1 for positive samples and 0 for negative samples. In this way, the number of positive samples indicated by the ground-truth label 105 may be counted by summing yᵢ^{k}. Samples other than positive samples are the number of negative samples indicated by the ground-truth label 105. In other examples, if the ground-truth label 105 uses other values to indicate positive samples and negative samples, localPₖ and localNₖ may also be counted in other ways, which is not limited herein. localPₖ and localNₖ may be determined as values of two metric parameters in the metric information at the client node 110-k.

In some embodiments, in block 330, the client node 110 may also determine the number (referred to as third number) of predicted scores of data samples 102 (i.e., positive samples) corresponding to the first-category labels that are exceeded by the predicted scores in the predicted score set based on the ranking results of the plurality of predicted scores in the predicted scores of all client nodes. The third number may be used as the value of another metric parameter of the performance indicator. This number may indicate that in the total set of data samples 102, the number of sample pairs whose positive samples are ranked higher than the remaining samples (in the case of ascending ranking).

For the individual client node 110, to obtain the ranking result of its predicted score among the predicted scores of all client nodes, the client node 110 needs to perform signaling interaction with the server node 120. FIG. 3B illustrates a flowchart of a signaling flow 350 of determining values of metric parameters according to some embodiments of the present disclosure.

In the signaling flow 350, the client node 110 sends 352 the predicted scores output by prediction model 125 to server node 120 for ranking.

In some embodiments, before sending the predicted scores to the server node 120, the client node 110 may randomly adjust the order of the plurality of predicted scores and send the plurality of predicted scores to the server node in the adjusted order. By randomly adjusting the order, it may be avoided that in some special cases, after the plurality of data samples 102 are sequentially input into the prediction model 125 at the client node, the output predicted scores have a certain order, such as from large to small or from small to large, which may lead to certain information leakage. Randomly adjusting the order may further strengthen the data privacy protection.

After receiving 354 the predicted scores, the server node 120 ranks the predicted score set 356 from the plurality of client nodes 110, thus obtaining the respective ranking results of the predicted scores from each client node 110 in the predicted score set.

In some embodiments, the server node 120 may rank the predicted score set in ascending order and assign a ranking value rᵢ^{k} to each predicted score sᵢ^{k} (the predicted score of the i^{th} data sample 102 of the client node 110-k). In some embodiments, the ranking value Tᵢ^{k} may indicate the number of other predicted score that the predicted score sᵢ^{k} exceeds in the predicted score set. For example, in ascending order, the lowest predicted score is assigned a ranking value of 0, indicating that it does not exceed (greater than) any other predicted score. The next predicted score is assigned a ranking value of 1, indicating that it is greater than one predicted score in the set, and so on. The assignment of such ranking values is beneficial for subsequent computing.

For the client node 110 receiving the predicted scores, the server node 120 sends 358 ranking results of its plurality of predicted scores in the overall predicted score set to the corresponding client node 110. At a single client node 110, based on the ranking results of received 360 from the server node 120, the client node 110 may determine 362 the third number of predicted scores of the data samples 102 (i.e., positive samples) corresponding to first-category labels that are exceeded by the predicted scores in the predicted score set. In some embodiments, at the client node 110-k, the third number may be determined as follows:

$${localSum}_{k} = {\sum }_{i = 1}^{\vert {X}_{k} \vert} {y}_{i}^{k} {r}_{i}^{k} \qquad ( 3 )$$

Wherein localSumₖ represents the third number, yᵢ^{k} represents the value of the ground-truth label 105 corresponding to the i^{th} data sample 102, and rᵢ^{k} represents the ranking value of the predicted score corresponding to the i^{th} data sample 102. As mentioned earlier, the ranking value rᵢ^{k} may be set to indicate the number of other predicted scores that the predicted score sᵢ^{k} exceeds in the predicted score set. In equation (3) above, it is also assumed that for positive samples, the value of yᵢ^{k} is 1, and for negative samples, the value yᵢ^{k} of is 0. In this way, by summing yᵢ^{k}, rᵢ^{k}, the number of samples (also the number of such predicted scores) whose predicted scores of positive samples rank higher than the predicted scores of the remaining samples may be determined. localSumₖ may be determined as a value (error value) of another metric parameter in the metric information at the client node 110-k.

localPₖ, localNₖ, and localSumₖ are all metric parameters that need to be determined in the example computing way of the AUC. Assuming that the total number of first-category labels at N client nodes 110 is P̅, the total number of second-category labels is N̅, and the total number of predicted scores of the data samples 102 (i.e., positive samples) corresponding to the first-category labels in the predicted score set that are exceeded by the predicted scores is globalSum, then the value of AUC of the model may be computed in the following way:

$$AUC = \frac{globalSum - \frac{\overline{P} ( \overline{P} - 1 )}{2}}{\overline{P} \overline{N}} \qquad ( 4 )$$

In some embodiments, the AUC may also be computed in other ways, and the computing of the AUC requires other metric parameter(s). In some embodiments, the client node 110 may determine the number of positive samples indicated by the ground-truth label 105 and the number of negative samples indicated by the ground-truth label 105 among the plurality of local ground-truth labels. In addition, the client node 110 may determine the number of positive samples with predicted scores greater than negative samples in all data samples 102 based on the predicted score set. Based on these three numbers, it may be the values of the metric parameters needed to compute the AUC value. Each client node 110 may determine the values of these metric parameters counted on their respective data sets.

Assume that the total number of data samples 102 at N client nodes 110 is L, and the number of positive samples indicated by the ground-truth label 105 is m, and the number of negative samples is n. In addition, the predicted score corresponding to each data sample 102 is Sᵢ, i∈[1, L]. By traversing the pairwise combination of positive samples and negative samples, m*n sample pairs Pi, i∈[1, m*n] may be formed, and the AUC may be determined as follows:

$$AUC\_corr = \frac{\sum I ( {P}_{i} )}{mn} , where \qquad ( 5 )$$

$$I ( {P}_{i} ) = \{ \begin{matrix}\begin{matrix}1 , the predicted score os positive samples in P is \\ greater than that of negative samples\end{matrix} \\ 0 , other cases\end{matrix}$$

The above discusses some example computing ways for AUC. If applicable, the AUC may also be determined from a probabilistic and statistical perspective based on other ways.

In some embodiments, in addition to AUC, other performance indicator of the prediction model 125 may also be evaluated, as long as such performance indicator may be determined from the plurality of predicted scores and the plurality of ground-truth labels 105. Accordingly, the client node 110 may determine the values of the metric parameters related to the performance indicator in the local predicted scores and ground-truth labels based on the type and computing way of the performance indicator. The embodiments of the present disclosure are not limited in this respect.

In the embodiments of the present disclosure, in order to implement privacy protection of the ground-truth label while determining the performance indicator of the prediction model 125, the values of the plurality of metric parameters determined by the client node 110 are not directly sent to the server node 120. On the contrary, in the signaling flow 200, after the client node 110 has determined the values of the plurality of metric parameters, the client node 110 performs 225 perturbations on the values of the plurality of metric parameters to obtain the perturbed values of the plurality of metric parameters. The client node 110 sends 230 the perturbed values of the plurality of metric parameters to the server node 120.

In the embodiments of the present disclosure, by performing perturbation, it is possible to avoid exposing the true value of the metric parameter counted based on the ground-truth label. How the client node performs perturbation will be discussed in detail below. Herein, “perturbation” is sometimes referred to as noise, interference, etc.

In some embodiments, it is expected that the performed perturbation may meet the protection of differential privacy of data. In order to better understand the embodiments of the present disclosure, differential privacy and random response mechanism will be briefly introduced below.

Assume that ϵ, δ is a real number greater than or equal to 0, that is, ϵ, δ∈ [symbol] ≥0, and [symbol] is a random mechanism (random algorithm). The so-called random mechanism refers to the fact that for a specific input, the output of the mechanism is not a fixed value, but follows a certain distribution. For a random mechanism [symbol] , it may be considered to the random mechanism [symbol] have (ϵ, δ)-differential privacy: for any two adjacent training datasets D and D′, and any subset S of possible outputs for [symbol] , there exists:

$$Pr [ ℳ ( D ) ∈ S ] \leq {e}^{ϵ} \cdot Pr [ ℳ ( {D}^{′} ) ∈ S ] + δ \qquad ( 6 )$$

Furthermore, if δ=0, it may also be considered that the random mechanism [symbol] have ϵ-differential privacy (ϵ-DP).

In the differential privacy mechanism, for the random mechanism [symbol] with (ϵ, δ)-differential privacy or ϵ-differential privacy, it is expected to act on two adjacent datasets and result in two outputs that are difficult to distinguish. In this way, observers may observe the output results and find it difficult to detect small changes in the input dataset of the algorithm, thus achieving the purpose of protecting privacy. If the random mechanism [symbol] acts on any adjacent datasets and the probability S of obtaining a specific output is similar, it will be considered that the algorithm is difficult to achieve the effect of differential privacy.

In the embodiments of the present disclosure, attention is paid to the differential privacy of the labels of the data samples, and the labels indicate results of binary classification. Therefore, following the setting of differential privacy, label differential privacy may be defined. Specifically, assuming ϵ, δ is a real number greater than or equal to 0, that is, ϵ, δ∈ [symbol] ≥0, and [symbol] is a random mechanism (random algorithm). If the following cases are met, it may be considered that the random mechanism [symbol] have (ϵ, δ)-label differential privacy: for any two adjacent training datasets D and D′, they differ only in the label of a single data sample, and any subset S of possible outputs for [symbol] , there exists:

$$Pr [ ℳ ( D ) ∈ S ] \leq {e}^{ϵ} \cdot Pr [ ℳ ( {D}^{′} ) ∈ S ] + δ \qquad ( 7 )$$

Furthermore, if δ=0, it may also be considered that the random mechanism [symbol] has ϵ-label differential privacy (ϵ-label DP). In other words, it is expected that after changing the label of data sample, the distribution of the output results from the random mechanism [symbol] is still small, making it difficult for observers to detect the change of the label.

The random mechanism may obey a certain probability distribution. In some embodiments, perturbation may be performed based on a Gaussian distribution or a Laplace distribution. In some embodiments, the client node 110 is used to perform random perturbation to the values of the respective metric parameters by determining a sensitivity value of the metric parameter value to be perturbation, and determining a probability distribution based on the sensitivity value. Next, the sensitivity will be first introduced, and then how to determine the probability distribution based on the sensitivity is introduced.

Assuming d is a positive integer, D is the collection of datasets, and f:D→R^{d} is a function used to change from D to R^{d}. The sensitivity of the function may be represented as Δf, which may be defined as Δf=max ∥f(D₁)−f(D₂)∥₁ and represent the maximum value among all pairs of data sets D1 and D2 in D, where D1 and D2 differ by at most one data element, and ∥⋅∥_{⊥} represents the l₁ norm. According to the above definition, the sensitivity refers to the maximum difference output by the function when at most one data element changes.

In different types of probability distribution, the sensitivity value may be introduced to define the specific probability distribution way. For example, for the Gaussian distribution mechanism, for any (ϵ, δ)∈(0, 1), the standard deviation of a Gaussian distribution may be defined as std=Δ\sqrt{2 log(1.25/δ)}/ϵ, where Δ represents the sensitivity value. Such Gaussian distribution has differential privacy of (ϵ, δ) (i.e., (ϵ, δ)-DP).

For another example, for the Laplace distribution mechanism (centered around 0) with a scale b, its probability density function is represented as

$$Lap ( x \vert b ) = \frac{1}{2 b} exp ( - \frac{\vert x \vert}{b} ) .$$

If the random noise (random perturbation) is determined by the Laplace distribution of Lap(Δ/ϵ), then it may be considered that such probability distribution can provide differential privacy of (ϵ,0).

Based on the above discussion, the client node 110 may determine sensitivity values related to perturbation of different metric parameters when performing perturbation and determine the corresponding probability distribution based on sensitivity values and a differential privacy mechanism. The client node 110 may apply perturbed value to the corresponding metric parameter based on the probability distribution.

In some embodiments, for the number localPₖ of first-category labels and the number localNₖ of second-category labels among the plurality of ground-truth labels 105 determined at the client node 110-k, the client node 110-k may perform perturbation to any one of the values. Because the other value may be determined by subtracting the previous number of perturbed values from the total number of ground-truth labels 105 at the node.

Specifically, the client node 110-k determines the sensitivity value related to the perturbation of localPₖ and localNₖ. For the value of the number of labels, it may be seen that if the value of a ground-truth label is changed randomly, localPₖ or localNₖ will be changed by 1 at most. Therefore, the sensitivity value here may be determined as Δ=1. Based on this sensitivity value, the client node 110-k may determine the probability distribution to be followed by the perturbation according to the differential privacy mechanism.

In some examples, the gaussian distribution may be determined and a perturbation (also referred to as noise or gaussian noise) may be performed based on the gaussian distribution. According to the Gaussian distribution mechanism discussed above, for any (ϵ, δ)∈(0, 1), the standard deviation of the Gaussian distribution may be determined as σ=Δ\sqrt{2 log(1.25/δ)}/ϵ, where the sensitivity value Δ=1. Such Gaussian distribution mechanism may meet differential privacy of (ϵ, δ) (i.e., (ϵ, δ)−DP).

In some examples, the Laplacian distribution may be determined and a perturbation (also referred to as noise or Laplacian noise) may be performed based on the Laplacian distribution. If differential privacy of (ϵ, δ) needs to be met, the width of the Laplace distribution may be determined as b=Δ/ϵ, that is, random noise is performed from the distribution of Lap(Δ/ϵ). The standard deviation of this distribution is σ=\sqrt{2}b=\sqrt{2}Δ/ϵ.

In some embodiments, for the third number localSumₖ of predicted scores in the predicted score set that are exceeded by predicted scores of data samples 102 (i.e., positive samples) corresponding to the first-category labels, the client node 110-k may determine the sensitivity value of the perturbation of the metric parameter.

In some embodiments, the sensitivity value related to localSumₖ is determined by the server node 120 from a global perspective. Such perturbation may obtain global privacy protection. From the global perspective, for the number of predicted scores in the predicted score set that are exceeded by predicted scores of positive samples corresponding to the first-category labels, its sensitivity may be determined as Δ=Q−1, where Q represents the total number of data samples at N client nodes 110. The sensitivity value here represents that if a data sample in the complete set of data sample is changed, localSumₖ will change Q−1 at most. In some embodiments, for a certain client node 110-k, it may receive information related to the sensitivity value from the server node 120. Such information may be the total number Q of data samples of the plurality of client nodes, or it may directly receive the sensitivity value Q−1, or other information that may determine the sensitivity value.

In some embodiments, the sensitivity value related to localSumₖ is determined locally by each client node 110-k. Such perturbation way may obtain local privacy protection. Specifically, the client node 110-k determines a highest ranking result among the respective ranking results of the plurality of local predicted scores, and determines the sensitivity value based on the highest ranking result, which may be represented as Δₖ=max (rᵢ^{k}). That is, for the local dataset at each client node, if one of the data samples is changed, the maximum value that localSumₖ will be changed is related to the highest ranking of the corresponding predicted score in the overall predicted score set.

After the client node 110-k determines the sensitivity value related to the localSumₖ in any way, based on the sensitivity value, the client node 110-k may determine the probability distribution to be followed by performing perturbation to the localSumₖ according to the differential privacy mechanism.

In some examples, the gaussian distribution may be determined and a perturbation (also referred to as noise or gaussian noise) may be performed based on the gaussian distribution. According to the Gaussian distribution mechanism discussed above, for any (ϵ, δ)∈(0, 1), the standard deviation of the Gaussian distribution may be determined as σ=Δ\sqrt{2 log(1.25/δ)}/ϵ. Such Gaussian distribution mechanism may meet differential privacy of (ϵ, δ) (i.e., (ϵ, δ)−DP).

In some examples, the Laplacian distribution may be determined and a perturbation (also referred to as noise or Laplacian noise) may be performed based on the Laplacian distribution. If differential privacy of (ϵ, δ) needs to be met, the width of the Laplace distribution may be determined as b=Δ/ϵ, that is, random noise is performed from the distribution of Lap(Δ/ϵ). The standard deviation of this distribution is σ=\sqrt{2}b=\sqrt{2}Δ/ϵ.

The ways to perform perturbation to some example metric parameters have been discussed above. For other different metric parameter, the sensitivity value and corresponding probability distribution may also be determined in a similar way to perform perturbation accordingly, which will not be repeated here.

By performing random perturbation, the values of the metric parameters determined from the local ground-truth labels does not need to be exposed. The client node 110 may send the perturbed values of the metric parameters to the server node 120.

Referring further to FIG. 2, the server node 120 receives 235 perturbed values of a plurality of metric parameters provided by each of the plurality of client nodes 110. The server node 120 aggregates 240 the perturbed values of the plurality of metric parameters from the plurality of client nodes 110 in a metric parameter-wise way to obtain aggregated values of the plurality of metric parameters. The server node 120 determines 245 a value of the performance indicator of the prediction model 125 based on the aggregated values of the plurality of metric parameters.

In some embodiments, it is assumed that the perturbed values of the metric parameters received from the client node 110 is localSumₖ′, localPₖ′ and localNₖ′, the server node 120 aggregates (for example, sums together) the values of these metric parameters of each client node 110 to obtain respectively:

$$globalSum = {\sum }_{k} {localSum}_{k}^{′} \qquad ( 8 )$$

$$\overline{P} = {\sum }_{k} {localP}_{k}^{′} \qquad ( 9 )$$

$$\overline{N} = {\sum }_{k} {localN}_{k}^{′} \qquad ( 10 )$$

Since it is determined based on the perturbed values, these aggregated values may not be exactly equivalent to the values computed from the ground-truth labels and predicted scores at the plurality of client nodes 110. However, since the plurality of client nodes 110 are all performed random perturbation, in some embodiments, the mean value of random perturbation (e.g., probability distribution) performed by the client node 110 is 0. In this way, through the aggregation operation at the server node 120, the random perturbation of each client node 110 may be cancelled out, making these aggregated values approximate to the true values of these metric parameters.

In some embodiments, the server node 120 may compute the value of the AUC of the prediction model 125 based on the above equation (4). In some embodiments, for the perturbation values of other metric parameters obtained from the client node 110, the server node 120 may also similarly aggregate them for computing the performance indicator. For example, for the computing way of the AUC given in the equation (5) above, the server node 120 may receive the perturbed values of the corresponding metric parameters from the client node 110 and aggregate them to compute the AUC.

Although the aggregation operation may cancel out the variance under the probability distribution with a mean value of 0, the determined value may have some variance compared with the true value of the performance indicator. But the inventor found through repeated experimentation and verification that the variance is small and within the allowable range. Especially, as the number of participating client nodes increases, the variance will be smaller.

In fact, strictly speaking, even if there is a true value label, in many algorithms for computing the AUC, the true value of AUC, that is, the area under the ROC curve, is approximated in an approximate way. Therefore, in the scenario where privacy protection of label data is required, according to various embodiments of the present disclosure, it is possible to allow the server node to determine a more accurate performance indicator while obtaining differential privacy protection of data.

An error between the value of the performance indicator (taking AUC as an example) computed according to some embodiments of the present disclosure and the true value will be discussed below. For convenience, it is temporarily assumed that when computing AUC, the server node uses values counted based on true labels, such as the true number of positive samples and the true number of negative samples.

When perturbation is performed based on global privacy protection, the standard deviation of computed AUC is

$$std ( AUC ) = std ( \frac{\sum {sum}_{i} - \frac{P * ( P - 1 )}{2}}{P * N} ) = \frac{\sqrt{c} * σ}{P * N} = \frac{σ}{P * N / \sqrt{c}} ,$$

where P is the number of positive samples, N is the number of negative samples, and c is the number of client nodes, σ is the standard deviation of the added perturbation (noise). From the above equation, it may be seen that as the number of client nodes decreases and the added noise decreases, the standard deviation of the computed AUC will also decrease. Taking Laplace mechanism as an example in global privacy protection, σ=\sqrt{2}(M−1)/ϵ, M is the total number of client nodes. Therefore, the variance of AUC may be computed as

$$std ( AUC ) = \frac{√ 2 ( M - 1 ) / ϵ}{P * N / \sqrt{c}} .$$

the standard deviation is

$$var ( AUC ) = {( \frac{√ 2 ( M - 1 ) / ϵ}{P * N / \sqrt{c}} )}^{2} ,$$

Assuming that there is only one data sample on each client node, that is, c=M, then the standard deviation is

$$\frac{√ 2 ( M - 1 ) / ϵ}{P * N / \sqrt{M}} .$$

This value is a small value in general applications.

When perturbation is performed based on local privacy protection, in order to facilitate computing, assuming that in an extreme case, there is only one data sample on each client node, that is, c=M, then the sensitivity values used by these client nodes are [0, 1, 2, . . . , M−1], respectively. Still taking Laplacian distribution as an example, the variance of the AUC computed is as follows, which is also a small value in general applications:

$$Variance ( AUC ) = \frac{{\sum }_{i = 1}^{c} {σ}_{i}^{2}}{{P}^{2} * {N}^{2}} = \frac{{\sum }_{i = 1}^{c} 2 * {( i - 1 )}^{2} / {ϵ}^{2}}{{P}^{2} * {N}^{2}} = \frac{2 * M ( M - 1 ) ( 2 M - 1 ) / 6 / {ϵ}^{2}}{{P}^{2} * {N}^{2}} = \frac{M ( M - 1 ) ( 2 M - 1 ) / 3 / {ϵ}^{2}}{{P}^{2} * {N}^{2}}$$

It should be understood that although AUC is taken as an example, in some embodiments, the server node 120 may additionally or alternatively compute the value of other performance indicator in a similar perturbation and interaction way.

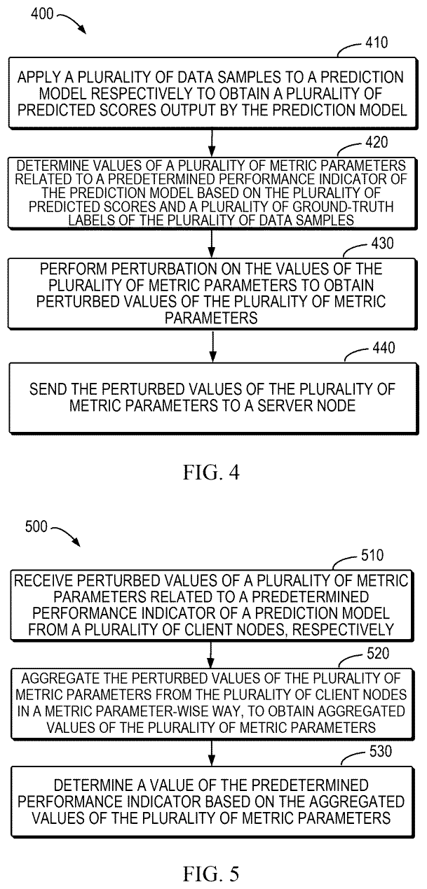

FIG. 4 illustrates a flowchart of a process 400 for model performance evaluation at a client node according to some embodiments of the present disclosure. The process 400 may be implemented at the client node 110.

In block 410, the client node 110 applies, at a client node, a plurality of data samples to a prediction model respectively to obtain a plurality of predicted scores output by the prediction model. The plurality of predicted scores indicate predicted probabilities that the plurality of data samples belong to a first category or a second category, respectively. In block 420, the client node 110 determines values of a plurality of metric parameters related to a predetermined performance indicator of the prediction model based on the plurality of predicted scores and a plurality of ground-truth labels of the plurality of data samples. In block 430, the client node 110 performs perturbation on the values of the plurality of metric parameters to obtain perturbed values of the plurality of metric parameters. In block 440, client node 110 sends the perturbed values of the plurality of metric parameters to a server node.

In some embodiments, determining the values of the plurality of metric parameters comprises: determining a first number of first-category labels among the plurality of ground-truth labels to be a value of a first metric parameter, a first-category label indicating a corresponding data sample belonging to the first category; and determining a second number of second-category labels among the plurality of ground-truth labels to be a value of a second metric parameter, a second-category label indicating a corresponding data sample belonging to the second category.

In some embodiments, performing perturbation on the values of the plurality of metric parameters comprises: determining a first sensitivity value related to perturbation of one of the first metric parameter and the second metric parameter; determining a first probability distribution based on the first sensitivity value and a differential privacy mechanism; performing, based on the first probability distribution, perturbation on the value of the metric parameter of the first metric parameter and the second metric parameter, to obtain a perturbed value of the metric parameter; and determining a perturbed value of the other one of the first metric parameter and the second metric parameter based on a total number of the plurality of ground-truth labels and the perturbed value of the metric parameter of the first metric parameter and the second metric parameter.

In some embodiments, determining the values of the plurality of metric parameters comprises: sending the plurality of predicted scores to the server node; receiving, from the server node, respective ranking results of the plurality of predicted scores in a predicted score set, the predicted score set comprising predicted scores sent by a plurality of client nodes comprising the client node; and determining, based on the respective ranking results of the plurality of predicted scores, a third number of predicted scores in the predicted score set that are exceeded by predicted scores of data samples corresponding to the first-category labels, to be a value of a third metric parameter.

In some embodiments, performing perturbation on the values of the plurality of metric parameters comprises: determining a second sensitivity value related to perturbation of the third metric parameter; determining a second probability distribution based on the second sensitivity value and a differential privacy mechanism; and performing, based on the second probability distribution, perturbation on the value of the third metric parameter.

In some embodiments, determining the second sensitivity value comprises: receiving information related to the second sensitivity value from the server node; and determining the second sensitivity value based on the received information.

In some embodiments, the information related to the second sensitivity value comprises a total number of data samples for the plurality of client nodes.

In some embodiments, determining the second sensitivity value comprises: determining a highest ranking result among the respective ranking results of the plurality of predicted scores; and determining the second sensitivity value based on the highest ranking result.

In some embodiments, the predetermined performance indicator at least comprises an area under curve (AUC) of a receiver operating characteristic (ROC) curve.

FIG. 5 illustrates a flowchart of a process 500 for model performance evaluation at a server node according to some embodiments of the present disclosure. The process 500 may be implemented at the server node 120.

In block 510, the server node 120 receives, at a server node, perturbed values of a plurality of metric parameters related to a predetermined performance indicator of a prediction model from a plurality of client nodes, respectively. In block 520, the server node 120 aggregates the perturbed values of the plurality of metric parameters from the plurality of client nodes in a metric parameter-wise way, to obtain aggregated values of the plurality of metric parameters. In block 530, the server node 120 determines a value of the predetermined performance indicator based on the aggregated values of the plurality of metric parameters.

In some embodiments, for a given client node among the plurality of client nodes, the perturbed values of the plurality of metric parameters indicate at least one of the following: a first number of first-category labels among a plurality of ground-truth labels at the given client node, a first-category label indicating a corresponding data sample belonging to the first category; a second number of second-category labels among the plurality of ground-truth value labels, as a value of a second metric parameter, a second-category label indicating a corresponding data sample belonging to the second category; and a third number of predicted scores in a predicted score set that are exceeded by predicted scores of data samples corresponding to the first-category label at the given client node, the predicted scores being determined by the prediction model based on the data samples, and the predicted score set comprising predicted scores sent from the plurality of client nodes.

In some embodiments, the process 500 further includes sending information related to the second sensitivity value to the plurality of client nodes, respectively.

In some embodiments, the information related to the second sensitivity value comprises a total number of data samples for the plurality of client nodes.

In some embodiments, the predetermined performance indicator at least comprises an area under curve (AUC) of a receiver operating characteristic (ROC) curve.

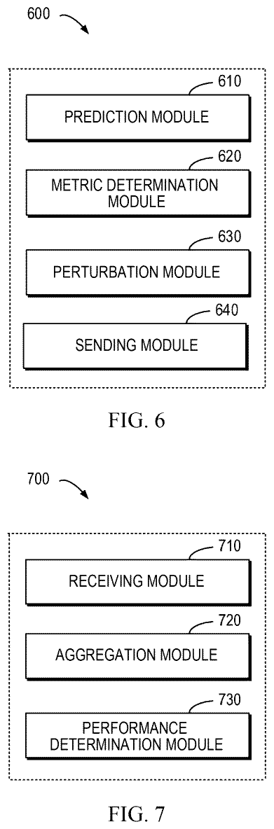

FIG. 6 illustrates a block diagram of an apparatus 600 for model performance evaluation at a client node based on some embodiments of the present disclosure. The apparatus 600 may be implemented or included in the client node 110. The various modules/components in the apparatus 600 may be implemented by hardware, software, firmware, or any combination of them.

As shown in the figure, the apparatus 600 includes a prediction module 610 configured to apply a plurality of data samples to a prediction model respectively, to obtain a plurality of predicted scores output by the prediction model. The plurality of predicted scores indicate respectively predicted probabilities that the plurality of data samples belonging to a first category or a second category. The apparatus 600 further includes a metric determination module configured to determine values of a plurality of metric parameters related to a predetermined performance indicator of the prediction model based on the plurality of predicted scores and a plurality of ground-truth labels of the plurality of data samples. The apparatus 600 further includes a perturbation module 630 configured to perform perturbation on the values of the plurality of metric parameters to obtain perturbed values of the plurality of metric parameters; and a sending module 640 configured to send the perturbed values of the plurality of metric parameters to a server node.

In some embodiments, the metric determination module 620 includes: a first determination module configured to determine a first number of first-category labels among the plurality of ground-truth labels to be a value of a first metric parameter, a first-category label indicating a corresponding data sample belonging to the first category; and a second determination module configured to determine a second number of second-category labels among the plurality of ground-truth labels to be a value of a second metric parameter, a second-category label indicating a corresponding data sample belonging to the second category.

In some embodiments, the perturbation module includes: a first sensitivity determination module configured to determine a first sensitivity value related to perturbation of one of the first metric parameter and the second metric parameter; a first distribution determination module configured to determine a first probability distribution based on the first sensitivity value and a differential privacy mechanism; a first perturbation application module configured to perform, based on the first probability distribution, perturbation on the value of the metric parameter of the first metric parameter and the second metric parameter, to obtain a perturbed value of the metric parameter; and a perturbed value determination module configured to determine a perturbed value of the other one of the first metric parameter and the second metric parameter based on a total number of the plurality of ground-truth labels and the perturbed value of the metric parameter of the first metric parameter and the second metric parameter.

In some embodiments, the metric determination module includes a score sending module configured to send the plurality of predicted scores to the server node; a result receiving module configured to receive, from the server node, respective ranking results of the plurality of predicted scores in a predicted score set, the predicted score set comprising predicted scores sent by a plurality of client nodes comprising the client node; and a third determination module configured to determine, based on the respective ranking results of the plurality of predicted scores, a third number of predicted scores in the predicted score set that are exceeded by predicted scores of data samples corresponding to the first-category labels, to be a value of a third metric parameter.

In some embodiments, the perturbation module includes: a second sensitivity determination module configured to determine a second sensitivity value related to perturbation of the third metric parameter; a second distribution determination module configured to determine a second probability distribution based on the second sensitivity value and a differential privacy mechanism; and a second perturbation application module configured to perform, based on the second probability distribution, perturbation on the value of the third metric parameter.

In some embodiments, the second sensitivity determination module includes a sensitivity receiving module configured to receive information related to the second sensitivity value from the server node; and an information based determination module configured to determine the second sensitivity value based on the received information.

In some embodiments, the information related to the second sensitivity value comprises a total number of data samples for the plurality of client nodes.

In some embodiments, the second sensitivity determination module includes: a ranking determination module configured to determine a highest ranking result among the respective ranking results of the plurality of predicted scores; and a ranking based determination module configured to determine the second sensitivity value based on the highest ranking result.

In some embodiments, the predetermined performance indicator at least comprises an area under curve (AUC) of a receiver operating characteristic (ROC) curve.

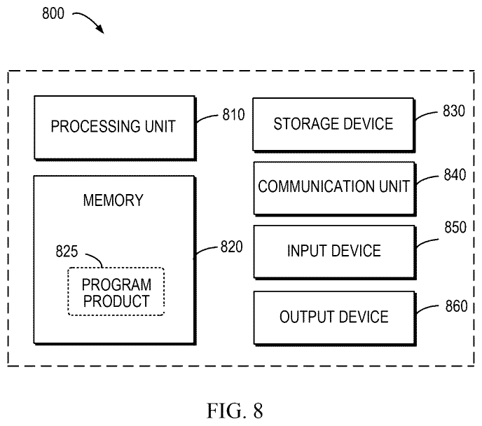

FIG. 7 illustrates a block diagram of an apparatus 700 for model performance evaluation at a server node according to some embodiments of the present disclosure. The apparatus 700 may be implemented or included in the server node 120. The various modules/components in apparatus 700 may be implemented by hardware, software, firmware, or any combination of them.

As shown in the figure, the apparatus 700 includes a receiving module 710 configured to receive, at a server node at a server node, perturbed values of a plurality of metric parameters related to a predetermined performance indicator of a prediction model from a plurality of client nodes, respectively. The apparatus 700 further includes an aggregation module 720 configured to aggregate the perturbed values of the plurality of metric parameters from the plurality of client nodes in a metric parameter-wise way, to obtain aggregated values of the plurality of metric parameters. The apparatus 700 further includes a performance determination module 730 configured to determine a value of the predetermined performance indicator based on the aggregated values of the plurality of metric parameters.

In some embodiments, for a given client node among the plurality of client nodes, the perturbed values of the plurality of metric parameters indicate at least one of the following: a first number of first-category labels among a plurality of ground-truth labels at the given client node, a first-category label indicating a corresponding data sample belonging to the first category; a second number of second-category labels among the plurality of ground-truth value labels, as a value of a second metric parameter, a second-category label indicating a corresponding data sample belonging to the second category; and a third number of predicted scores in a predicted score set that are exceeded by predicted scores of data samples corresponding to the first-category label at the given client node, the predicted scores being determined by the prediction model based on the data samples, and the predicted score set comprising predicted scores sent from the plurality of client nodes.

In some embodiments, the apparatus 700 further includes a sensitivity sending module configured to send information related to the second sensitivity value to the plurality of client nodes, respectively.

In some embodiments, the information related to the second sensitivity value comprises a total number of data samples for the plurality of client nodes.

In some embodiments, the predetermined performance indicator at least comprises an area under curve (AUC) of a receiver operating characteristic (ROC) curve.

FIG. 8 illustrates a block diagram of a computing device/system 800 capable of implementing one or more embodiments of the present disclosure. It should be understood that the computing device/system 800 shown in FIG. 8 is only illustrative and should not constitute any limitation on the functionality and scope of the embodiments described herein. The computing device/system 800 shown in FIG. 8 may be used to implement the client node 110 or server node 120 of FIG. 1.

As shown in FIG. 8, the computing device/system 800 is in the form of a general-purpose computing device. The components of computing device/system 800 may include, but are not limited to, one or more processors or processing units 810, a memory 820, a storage device 830, one or more communication units 840, one or more input devices 850, and one or more output devices 860. The processing unit 810 may be an actual or virtual processor and may execute various processes based on the programs stored in the memory 820. In a multiprocessor system, multiple processing units execute computer executable instructions in parallel to improve the parallel processing capability of the computing device/system 800.

The computing device/system 800 typically includes multiple computer storage medium. Such medium may be any available medium that may be accessed by the computing devices/systems 800, including but not limited to volatile and non-volatile medium, removable and non-removable medium. The memory 820 may be volatile memory (such as registers, a cache, a random access memory (RAM)), a non-volatile memory (such as a read-only memory (ROM), an electrically erasable programmable read-only memory (EEPROM), a flash memory), or some combination of them. The storage device 830 may be a removable or non-removable medium, and may include machine readable medium such as flash drives, disks, or any other medium that may be used to store information and/or data (such as training data for training) and may be accessed within the computing device/system 800.

The computing device/system 800 may further include additional removable/non-removable, volatile/nonvolatile storage medium. Although not shown in FIG. 8, a disk driver for reading from or writing to a removable, non-volatile disk (such as a “floppy disk”) and an optical disk driver for reading from or writing to a removable, non-volatile optic disk may be provided. In these cases, each driver may be connected to the bus (not shown) by one or more data medium interfaces. The memory 820 may include a computer program product 825, which has one or more program modules configured to execute various methods or acts of various embodiments of the present disclosure.

The communication unit 840 communicates with a further computing devices through the communication medium. Additionally, the functionality of the components of the computing device/system 800 may be implemented in a single computing cluster or multiple computing machines which may communicate through communication connections. Therefore, the computing device/system 800 may be operated in a networked environment using logical connections with one or more other servers, network personal computers (PCs), or another network node.

The input device 850 may be one or more input devices, such as a mouse, a keyboard, a trackball, etc. The output device 860 may be one or more output devices, such as a display, a speaker, a printer, etc. The computing device/system 800 may also communicate with one or more external devices (not shown) as needed through the communication unit 840, such as storage devices, display devices, etc., to communicate with one or more devices that enable users to interact with the computing device/system 800, or to communicate with any device (such as a network card, a modem, etc.) that enables the computing device/system 800 to communicate with one or more other computing devices. Such communication may be performed via an input/output (I/O) interface (not shown).

According to the exemplary embodiments of the present disclosure, a computer readable storage medium is provided, on which computer executable instructions or computer programs are stored, wherein the computer-executable instructions or computer programs are executed by a processor to implement the methods described above.

According to the example implementations of the present disclosure, a computer program product is also provided, which is tangibly stored on a non-transient computer readable medium and includes computer-executable instructions, which are executed by a processor to implement the methods described above.

Herein, various aspects of the present disclosure are described with reference to flowcharts and/or block diagrams of the methods, apparatuses, devices, and computer program products implemented in accordance with the present disclosure. It should be understood that each block in the flowchart and/or block diagram, and the combination of each block in the flowchart and/or block diagram, may be implemented by computer readable program instructions.

These computer-readable program instructions may be provided to the processing units of general-purpose computers, specialized computers, or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be executed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes may also be executed in a reverse order, depending on the functionality involved. It should also be noted that each block in the block diagram and/or the flowchart, and combinations of blocks in the block diagram and/or the flowchart, may be implemented by a dedicated hardware-based system that executes the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various implementations disclosed herein.

1. A method of model performance evaluation, comprising:
applying, at a client node, a plurality of data samples to a prediction model respectively to obtain a plurality of predicted scores output by the prediction model, the plurality of predicted scores indicating respectively predicted probabilities that the plurality of data samples belong to a first category or a second category;
determining values of a plurality of metric parameters related to a predetermined performance indicator of the prediction model based on the plurality of predicted scores and a plurality of ground-truth labels of the plurality of data samples;
performing perturbation on the values of the plurality of metric parameters to obtain perturbed values of the plurality of metric parameters; and
sending the perturbed values of the plurality of metric parameters to a server node.

2. The method of claim 1, wherein determining the values of the plurality of metric parameters comprises:
determining a first number of first-category labels among the plurality of ground-truth labels to be a value of a first metric parameter, a first-category label indicating a corresponding data sample belonging to the first category; and
determining a second number of second-category labels among the plurality of ground-truth labels to be a value of a second metric parameter, a second-category label indicating a corresponding data sample belonging to the second category.

3. The method of claim 2, wherein performing perturbation on the values of the plurality of metric parameters comprises:
determining a first sensitivity value related to perturbation of one of the first metric parameter and the second metric parameter;
determining a first probability distribution based on the first sensitivity value and a differential privacy mechanism;
performing, based on the first probability distribution, perturbation on the value of the metric parameter of the first metric parameter and the second metric parameter, to obtain a perturbed value of the metric parameter; and
determining, based on a total number of the plurality of ground-truth labels and the perturbed value of the metric parameter of the first metric parameter and the second metric parameter, a perturbed value of the other one of the first metric parameter and the second metric parameter.

4. The method of claim 1, wherein determining the values of the plurality of metric parameters comprises:
sending the plurality of predicted scores to the server node;
receiving, from the server node, respective ranking results of the plurality of predicted scores in a predicted score set, the predicted score set comprising predicted scores sent by a plurality of client nodes comprising the client node; and
determining, based on the respective ranking results of the plurality of predicted scores, a third number of predicted scores in the predicted score set that are exceeded by predicted scores of data samples corresponding to the first-category labels, to be a value of a third metric parameter.

5. The method of claim 4, wherein performing perturbation on the values of the plurality of metric parameters comprises:
determining a second sensitivity value related to perturbation of the third metric parameter;
determining a second probability distribution based on the second sensitivity value and a differential privacy mechanism; and
performing, based on the second probability distribution, perturbation on the value of the third metric parameter.

6. The method of claim 5, wherein determining the second sensitivity value comprises:
receiving information related to the second sensitivity value from the server node; and
determining the second sensitivity value based on the received information.

7. The method of claim 6, wherein the information related to the second sensitivity value comprises a total number of data samples for the plurality of client nodes.

8. The method of claim 5, wherein determining the second sensitivity value comprises:
determining a highest ranking result among the respective ranking results of the plurality of predicted scores; and
determining the second sensitivity value based on the highest ranking result.

9. The method of claim 1, wherein the predetermined performance indicator at least comprises an area under curve (AUC) of a receiver operating characteristic (ROC) curve.

10. A method of model performance evaluation, comprising:
receiving, at a server node, perturbed values of a plurality of metric parameters related to a predetermined performance indicator of a prediction model from a plurality of client nodes, respectively;
aggregating the perturbed values of the plurality of metric parameters from the plurality of client nodes in a metric parameter-wise way, to obtain aggregated values of the plurality of metric parameters; and
determining a value of the predetermined performance indicator based on the aggregated values of the plurality of metric parameters.

11. The method of claim 10, wherein for a given client node among the plurality of client nodes, the perturbed values of the plurality of metric parameters indicate at least one of the following:
a first number of first-category labels among a plurality of ground-truth labels at the given client node, a first-category label indicating a corresponding data sample belonging to the first category;
a second number of second-category labels among the plurality of ground-truth value labels, as a value of a second metric parameter, a second-category label indicating a corresponding data sample belonging to the second category; and
a third number of predicted scores in a predicted score set that are exceeded by predicted scores of data samples corresponding to the first-category label at the given client node, the predicted scores being determined by the prediction model based on the data samples, and the predicted score set comprising predicted scores sent from the plurality of client nodes.

12. The method of claim 11, further comprising:
sending information related to the second sensitivity value to the plurality of client nodes, respectively.

13. The method of claim 12, wherein the information related to the second sensitivity value comprises a total number of data samples for the plurality of client nodes.

14. The method of claim 10, wherein the predetermined performance indicator at least comprises an area under curve (AUC) of a receiver operating characteristic (ROC) curve.

15-16. (canceled)

17. An electronic device comprising:
at least one processing unit; and
at least one memory coupled to the at least one processing unit and storing instructions for execution by the at least one processing unit, the instructions, when executed by the at least one processing unit, causing the device to perform acts of model performance evaluation, the acts comprising:
applying, at a client node, a plurality of data samples to a prediction model respectively to obtain a plurality of predicted scores output by the prediction model, the plurality of predicted scores indicating respectively predicted probabilities that the plurality of data samples belong to a first category or a second category;
determining values of a plurality of metric parameters related to a predetermined performance indicator of the prediction model based on the plurality of predicted scores and a plurality of ground-truth labels of the plurality of data samples;
performing perturbation on the values of the plurality of metric parameters to obtain perturbed values of the plurality of metric parameters; and
sending the perturbed values of the plurality of metric parameters to a server node,
sending the perturbed values of the plurality of metric parameters to a server node.

18-20. (canceled)

21. The device of claim 17, wherein determining the values of the plurality of metric parameters comprises:
determining a first number of first-category labels among the plurality of ground-truth labels to be a value of a first metric parameter, a first-category label indicating a corresponding data sample belonging to the first category; and
determining a second number of second-category labels among the plurality of ground-truth labels to be a value of a second metric parameter, a second-category label indicating a corresponding data sample belonging to the second category.

22. The device of claim 21, wherein performing perturbation on the values of the plurality of metric parameters comprises:
determining a first sensitivity value related to perturbation of one of the first metric parameter and the second metric parameter;
determining a first probability distribution based on the first sensitivity value and a differential privacy mechanism;
performing, based on the first probability distribution, perturbation on the value of the metric parameter of the first metric parameter and the second metric parameter, to obtain a perturbed value of the metric parameter; and
determining, based on a total number of the plurality of ground-truth labels and the perturbed value of the metric parameter of the first metric parameter and the second metric parameter, a perturbed value of the other one of the first metric parameter and the second metric parameter.

23. The device of claim 17, wherein determining the values of the plurality of metric parameters comprises:
sending the plurality of predicted scores to the server node;
receiving, from the server node, respective ranking results of the plurality of predicted scores in a predicted score set, the predicted score set comprising predicted scores sent by a plurality of client nodes comprising the client node; and
determining, based on the respective ranking results of the plurality of predicted scores, a third number of predicted scores in the predicted score set that are exceeded by predicted scores of data samples corresponding to the first-category labels, to be a value of a third metric parameter.

24. The device of claim 23, wherein performing perturbation on the values of the plurality of metric parameters comprises:
determining a second sensitivity value related to perturbation of the third metric parameter;
determining a second probability distribution based on the second sensitivity value and a differential privacy mechanism; and
performing, based on the second probability distribution, perturbation on the value of the third metric parameter.

25. The device of claim 24, wherein determining the second sensitivity value comprises:
receiving information related to the second sensitivity value from the server node; and
determining the second sensitivity value based on the received information.
